(19) United States
(12) Patent Application Publication
(10) Pub. No.: US 2026/0316761 A1
(43) Pub. Date: Oct. 15, 2026

(54) Driving Assistance System and Driving Assistance Method for a Vehicle

(71) Applicant: BAYERISCHE MOTOREN WERKE AKTIENGESELLSCHAFT, München (DE)

(72) Inventors: Jakob HUEMER, Muenchen (DE); Andreas SPAETH, Lindau (DE)

(21) Appl. No.: 19/482,825

(22) PCT Filed: May 16, 2024
(86) PCT No.: PCT/EP2024/063557

§ 371 Date: Nov. 10, 2025

(30) Foreign Application Priority Data
May 25, 2023 (DE) 10 2023 113 834.0

(51) Int. Cl. B60W 30/18; B60W 30/16; B60W 50/14

(52) U.S. Cl. CPC B60W 30/18163; B60W 30/16; B60W 50/14; B60W 2420/403; B60W 2420/408; B60W 2554/4042; B60W 2554/802; B60W 2556/40

(57) ABSTRACT

A driving assistance system for a vehicle includes: a navigation module which is configured to provide a driving route for the vehicle, wherein the vehicle is located on a first lane of a multi-lane road section of the driving route, wherein the driving route includes an event, and wherein the event is an exit from the multi-lane road section and/or a bend and/or a reduction in the number of lanes; a module for detecting another vehicle, which is configured to determine at least one vehicle property of at least one other vehicle located ahead of the vehicle on the first lane; and an assistance module which is configured to decide, based on a distance and/or time up until the event is reached and on the at least one vehicle property of the at least one other vehicle, whether or not an overtaking maneuver for overtaking the at least one other vehicle should be performed.

### BACKGROUND AND SUMMARY

The present disclosure relates to a driving assistance system for a vehicle, to a vehicle having such a driving assistance system, to a driving assistance method for a vehicle and to a storage medium for carrying out the driving assistance method. The present disclosure relates in particular to a driving strategy during lane changes for overtaking other vehicles.

Driving assistance systems for automated driving are increasingly gaining importance. Automated driving can take place with various degrees of automation. Exemplary degrees of automation are assisted, semiautomated, conditionally automated, highly automated or fully automated driving. The above-mentioned five degrees of automation correspond to SAE levels 1 to 5 of the norm SAE J3016 (SAE—Society of Automotive Engineering) according to the version of Apr. 30, 2021. In fully automated driving (SAE level 5), all aspects of the dynamic driving task which are also managed by a human driver can be carried out by the system under any roadway and environmental condition.

One example of a driving assistance system is the lane change assistant which can carry out an automatic lane change or assists a driver during a manual lane change. For this purpose, the lane change assistant uses data of a surroundings sensor system which perceives the surroundings on a visual basis, both in the range visible to humans and also in the nonvisible range. The surroundings sensor system can comprise, for example, a camera, a radar and/or a LiDAR.

Typical lane change assistants are limited, however, insofar as there is often no adequate driving strategy to determine how a lane change can be carried out and a navigation destination can be reached at the same time. As a result, an availability and/or reliability of the lane change assistant can be reduced. Moreover, risky overtaking maneuvers can occur without an adequate driving strategy, which can impair safety in road traffic.

It is an object of the present disclosure to provide a driving assistance system for a vehicle, a vehicle having such a driving assistance system, a driving assistance method for a vehicle and a storage medium for carrying out the driving assistance method, which enable reliable operation of a lane change assistant. Moreover, it is an object of the present disclosure to improve safety in road traffic.

This object is achieved by the subject matter of the independent claims. Advantageous designs are specified in the dependent claims.

According to one independent aspect of the present disclosure, a driving assistance system for a vehicle, in particular a motor vehicle, is provided. The driving assistance system comprises a navigation module configured to provide (for example, calculate or receive) a travel route for the vehicle, wherein the vehicle is located on a first lane of a multilane route section of the travel route, wherein the travel route comprises an event, and wherein the event comprises or is, for example, an exit from the multilane route section and/or a cornering action and/or a reduction of a number of lanes; an other-vehicle recognition module configured to determine at least one vehicle property of at least one other vehicle located in front of the vehicle on the first lane; and an assistance module configured to decide, based on a distance and/or time until reaching the event (i.e. reaching the exit and/or reaching the curve or beginning of the cornering action) and the at least one vehicle property of the at least one other vehicle, whether or not an overtaking maneuver for overtaking the at least one other vehicle is to be carried out.

According to the invention, the driving assistance system observes at least one other vehicle which is driving in front of the vehicle and is potentially to be overtaken. In particular, the driving assistance system can observe a movement status of the at least one other vehicle, such as a longitudinal speed, a longitudinal and/or lateral acceleration, a turn signal status, etc. Moreover, the driving assistance system determines a distance and/or time until reaching the event, thus the exit or curve. Based on this information and optionally in consideration of further factors (for example an acceleration potential of the vehicle), the driving assistance system calculates whether it is possible to overtake the at least one other vehicle by the time of reaching the event, so that a subsequent maneuver for safely passing the event is possible. If a calculated quality measure is not sufficient or is not calculable, lane changes for overtaking can be suppressed. As a result, an improved driving strategy with respect to lane changes for a specified travel route can be provided, so that reliable operation of the lane change assistant can be enabled and safety in road traffic can be improved.

The navigation module and/or the other-vehicle recognition module and/or the assistance module can be implemented in a common software and/or hardware module. Alternatively thereto, the navigation module and/or the other-vehicle recognition module and/or the assistance module can be implemented in separate software and/or hardware modules.

The navigation module is capable of quickly and efficiently calculating optimum travel routes from a starting point to a route destination and a prediction for arrival times and/or journey times. The navigation module generally uses a routing algorithm for the route planning. In such a routing algorithm, for example, a path selection can be made in that decision criteria (metrics) are offset with weighting factors in consideration of topological properties (for example turnoff links) and dynamic properties (for example current speed, construction sites) of route sections for each possible path. These can also change over the runtime, for example since the algorithm has learned from the preferences of the driver and accesses this data knowledge.

The term “event” as used in the scope of the present disclosure refers to a driving situation which is to be managed by the vehicle, for example exiting from the multilane route section onto an adjoining route section of the travel route and/or a curve or cornering action on the travel route. The curve can in some embodiments have a radius which is equal to or less than a threshold value. The threshold value can, for example, specify a tight curve and/or a radius from which safe overtaking is no longer possible. Further events can moreover comprise an upcoming reduction of the number of lanes due to route conditions, such as a construction site and/or lanes branching off.

The at least one vehicle property of the other vehicle is preferably selected from the group comprising or consisting of a vehicle speed of the other vehicle, an acceleration behavior of the other vehicle, a deceleration behavior of the other vehicle, lateral guidance of the other vehicle and a status of a direction indicator of the other vehicle.

The vehicle speed of the other vehicle is a longitudinal speed of the other vehicle, thus a speed in the direction of travel. In some embodiments, the other-vehicle recognition module can be configured to detect the vehicle speed of the other vehicle over time, for example in order to prepare a speed profile of the other vehicle for a further analysis.

The acceleration behavior of the other vehicle relates to the longitudinal speed of the other vehicle and is a positive acceleration (becoming faster). In some embodiments, the other-vehicle recognition module can be configured to detect the acceleration behavior of the other vehicle over time, for example in order to prepare a chronological behavior profile of the other vehicle for a further analysis. For example, it can be recognized from an acceleration of the other vehicle that the other vehicle will soon be faster than the ego vehicle and therefore an overtaking procedure is not to be carried out.

The deceleration behavior of the other vehicle relates to the longitudinal speed of the other vehicle and is a negative acceleration (becoming slower). In some embodiments, the other-vehicle recognition module can be configured to detect the deceleration behavior of the other vehicle over time, for example in order to prepare a chronological behavior profile of the other vehicle for a further analysis. For example, it can be recognized from a deceleration of the other vehicle that the other vehicle will likewise exit at the exit and therefore an overtaking procedure is not to be carried out.

The lateral guidance of the other vehicle relates to a movement component of the other vehicle perpendicular to the direction of travel or longitudinal speed. In some embodiments, the other-vehicle recognition module can be configured to detect the lateral guidance behavior of the other vehicle over time, for example in order to prepare a chronological behavior profile of the other vehicle for a further analysis. For example, it can be recognized from lateral guidance of the other vehicle to the left that the other vehicle is carrying out a lane change to the left and therefore an overtaking procedure is not to be carried out.

The status of the direction indicator (turn signal) of the other vehicle indicates whether or not the direction indicator is active. For example, it can be recognized from an active direction indicator to the left that the other vehicle is carrying out a lane change to the left and therefore an overtaking procedure is not to be carried out. Similarly, it can be recognized from an active direction indicator to the right that the other vehicle will likewise exit at the exit and therefore an overtaking procedure is not to be carried out.

Preferably, the at least one vehicle property of the other vehicle comprises (or is) the vehicle speed of the other vehicle, wherein the assistance module is configured to decide, in consideration of the distance and/or the time until reaching the event, that the overtaking maneuver for overtaking the other vehicle is to be carried out if the vehicle speed of the other vehicle is less than a vehicle speed of the vehicle and to decide that the overtaking maneuver for overtaking the other vehicle is not to be carried out if the vehicle speed of the other vehicle is equal to or greater than the vehicle speed of the vehicle. Overtaking attempts which are risky and/or cannot be carried out can thus be avoided.

The driving assistance system is preferably configured to determine the distance and/or time until reaching the event based on surroundings data of a surroundings sensor system of the vehicle and/or digital map data of the navigation module and/or external information which is received from at least one external unit. Moreover, the distance and/or time of an event, such as the length of the deceleration lane of an exit, can be determined.

Moreover, the driving assistance system can be configured to assess the possibility of overtaking on the right in the route section. Regional regulations can be stored for this purpose. For example, in Germany, the possibility of overtaking on the right can be ascertained from the width of the lane marking in the region of an event for exiting.

Additionally or alternatively, the driving assistance system can be configured to determine the at least one vehicle property of the other vehicle based on surroundings data of the surroundings sensor system of the vehicle and/or external information which is received from at least one external unit.

In some embodiments, the surroundings sensor system comprises at least one LiDAR system and/or at least one radar system and/or at least one camera and/or at least one ultrasound system. The surroundings sensor system can provide the surroundings data (also referred to as “environmental data”) which depict a surrounding region of the vehicle. The driving assistance system can analyze the surroundings data in order to determine the distance and/or time until reaching the event and/or the at least one vehicle property of the other vehicle.

The at least one external unit preferably comprises at least one other vehicle and/or one central unit and/or one technical traffic infrastructure.

The at least one other vehicle that represents the at least one external unit preferably comprises or is the other vehicle, which is possibly to be overtaken, and/or another other vehicle in the vehicle surroundings.

In some embodiments, information with respect to the distance and/or time until reaching the event (for example a geoposition of the exit or of the beginning of the curve) and/or the at least one vehicle property of the other vehicle (for example speed data and/or navigation route) can be transmitted immediately or directly, for example, via a V2V communication connection or a mobile network, V2I communication connection, from the at least one other vehicle to the ego vehicle.

The at least one external unit preferably comprises, or is, a central unit, such as a server or a backend. Therefore, the information with respect to the distance and/or time until reaching the event (for example a geoposition of the exit or of the beginning of the curve) and/or the at least one vehicle property of the other vehicle (for example speed data) can be transmitted mediately or indirectly, for example, from the at least one other vehicle to the ego vehicle. For this purpose, both the ego vehicle and the at least one other vehicle can communicate, for example, via a mobile network with the central unit; the at least one other vehicle can send the information to the central unit, and the central unit can then forward the information to the ego vehicle.

The at least one external unit preferably comprises, or is, a technical infrastructure. The technical traffic infrastructure can in some embodiments comprise cameras and/or another sensor system, which can be installed, for example, at a roadside, in traffic control systems, in toll stations, etc. The detection data generated by the technical traffic infrastructure can be used in order to determine the information with respect to the distance and/or time until reaching the event (for example a geoposition of the exit or of the beginning of the curve) and/or the at least one vehicle property of the other vehicle (for example speed data).

In some embodiments, the technical traffic infrastructure can determine the information itself from the detection data. For example, the technical traffic infrastructure can recognize the other vehicle using a camera and determine a speed profile. The technical traffic infrastructure can transmit the information thus obtained directly, for example, by means of V2X communication to the ego vehicle of the present disclosure, or can transmit the journey information, for example, via a mobile network to the central unit which then in turn transmits the information, for example, via a mobile network to the ego vehicle.

In some embodiments, the technical traffic infrastructure cannot determine the information itself from the detection data. For example, the technical traffic infrastructure can transmit the detection data, such as image data, to the ego vehicle and/or the above-mentioned central unit, which ego vehicle/central unit then ascertains the information from the detection data.

The assistance module is preferably configured to furthermore decide based on at least one item of vehicle-internal information whether or not the overtaking maneuver for overtaking the other vehicle is to be carried out.

The at least one item of vehicle-internal information preferably comprises:
an acceleration capacity of the vehicle (for example maximum possible acceleration); and/or
a speed limit (for example recognized by traffic sign recognition); and/or
an internal speed specification, in particular a driver speed specification (for example cruise control, maximum comfort speed, etc.); and/or
an internal acceleration specification, in particular a driver acceleration specification (for example energy efficiency specifications, maximum comfort acceleration, etc.); and/or
an internal deceleration specification, in particular a driver deceleration specification (for example maximum possible deceleration, maximum comfort deceleration, etc.).

The assistance module is preferably configured to furthermore decide based on a speed specification for the event whether or not the overtaking maneuver for overtaking the other vehicle is to be carried out. The speed specification can be, for example, a speed limit for the exit and/or cornering action.

In some embodiments, the assistance module can be configured to decide in consideration of the at least one vehicle property of the other vehicle and the distance and/or the time until reaching the event that the overtaking maneuver for overtaking the other vehicle is to be carried out if the speed specification for the event is achievable (for example safely and/or comfortably) by the time of reaching the event, and to decide that the overtaking maneuver for overtaking the other vehicle is not to be carried out if the speed specification for the event is not achievable (for example safely and/or comfortably) by the time of reaching the event.

The assistance module is preferably configured to carry out the overtaking maneuver for overtaking the other vehicle in an automated manner if it is decided that the overtaking maneuver is to be carried out, wherein the overtaking maneuver comprises a first lane change from the first lane to a second lane of the multilane route section of the travel route and a second lane change back from the second lane to the first lane. The first lane change takes place here in the direction of travel behind the other vehicle and the second lane change takes place in the direction of travel in front of the other vehicle, so that the overtaking maneuver is carried out.

If it is decided that the overtaking maneuver is not to be carried out, no lane changes take place and the vehicle continues to travel behind the other vehicle.

The assistance module can be configured to carry out the overtaking maneuver having the associated lane changes furthermore based on surroundings data which are provided by the surroundings sensor system of the vehicle. In combination with the information with respect to the distance and/or time until reaching the event (for example a geoposition of the exit or of the beginning of the curve) and/or the at least one vehicle property of the other vehicle (for example speed data), a safe lane change strategy can be determined. Risks during lane changes can thus be minimized.

The assistance module is preferably configured to carry out automatic lateral guidance and optionally automatic longitudinal guidance of the vehicle for the overtaking maneuver. In particular, the assistance module can be configured to carry out automatic lane changes. In other words, the driving assistance system can be configured for automated driving, and in particular can be an active lane change assistant.

The term “automated driving” is understood in the context of the document as driving using automated longitudinal and/or lateral guidance. Automated driving can be, for example, driving for a longer time on the freeway or driving for limited time in the context of parking. The term “automated driving” comprises automated driving with an arbitrary degree of automation. Exemplary degrees of automation are assisted, semiautomated, conditionally automated, highly automated and fully automated driving (with increasing degree of automation in each case). The above-mentioned five degrees of automation correspond to SAE levels 1 to 5 of the norm SAE J3016 (SAE—Society of Automotive Engineering) according to the version of Apr. 30, 2021.

In assisted driving (SAE level 1), the system carries out the longitudinal or lateral guidance in specific driving situations. In semiautomated driving (SAE level 2), the system takes over the longitudinal and lateral guidance in specific driving situations, wherein the driver has to continuously monitor the system as in assisted driving. In conditionally automated driving (SAE level 3), the system takes over the longitudinal and lateral guidance in specific driving situations without the driver having to continuously monitor the system; however, the driver has to be capable within a specific time of taking over the vehicle guidance upon request by the system. In highly automated driving (SAE level 4), the system takes over the vehicle guidance in specific driving situations, even if the driver does not react to a request to intervene, so that the driver is dispensed with as a fallback level. In fully automated driving (SAE level 5), all aspects of the dynamic driving task can be carried out by the system under any roadway and environmental condition, which are also managed by a human driver.

In addition, the term “at least semiautomated driving or maneuvering” is also understood in the context of the document as semiautomated, conditionally automated, highly automated, fully automated driving. In other words, the term “at least semiautomated driving” is thus understood to mean a degree of automation from SAE level 2 inclusive.

The driving assistance system or the lane change assistant of the present disclosure can in some embodiments correspond to a degree of automation in which at least automatic lateral guidance or a lane change is possible upon a user input by the driver. Such a degree of automation can be, for example, SAE level 2.

The driving assistance system preferably furthermore comprises at least one output device configured to output driver notifications with respect to the decision on the overtaking maneuver. In particular, the assistance module can be configured to actuate the at least one output device to output at least one driver notification with respect to the decision on the overtaking maneuver. The output of driver notifications can take place in particular if the vehicle is driven manually. The driver notifications can give the driver notifications on the overtaking maneuver, in particular the lane changes. For example, the driver notifications can indicate whether the overtaking maneuver is possible, impossible, nonhazardous, hazardous, advantageous, etc. For example, the driving assistance system can propose the overtaking maneuver having the lane changes if these are possible and/or advantageous and/or nonhazardous according to the lane change planning.

The vehicle preferably comprises at least one output device for outputting the driver notifications, such as optical and/or acoustic warnings and/or information. The at least one output device can comprise at least one display device and/or at least one loudspeaker. The at least one display device can comprise a display, in particular an LCD display, a plasma display or an OLED display. Additionally or alternatively, the at least one display device can comprise a projection device configured to show information directly in the field of view of the driver, in particular to project it on a windshield. In some embodiments, the at least one display device can be a central information output device of an infotainment system, such as a head unit or a pillar-to-pillar display. The at least one output device is preferably permanently installed in the vehicle.

According to a further independent aspect of the present disclosure, a vehicle, in particular motor vehicle, is provided. The vehicle comprises the driving assistance system according to the embodiments of the present disclosure.

The term vehicle comprises passenger vehicles, trucks, buses, caravans, motorcycles, etc. used to convey people, goods, etc. In particular, the term comprises motor vehicles for conveying people.

According to a further independent aspect of the present disclosure, a driving assistance method for a vehicle, in particular a motor vehicle, is specified. The driving assistance method comprises providing a travel route for the vehicle, wherein the vehicle is located on a first lane of a multilane route section of the travel route, wherein the travel route comprises an event, and wherein the event comprises, for example, an exit from the multilane route section and/or cornering action and/or a reduction of the number of lanes; determining at least one vehicle property of at least one other vehicle which is located in front of the vehicle on the first lane; and deciding, based on a distance and/or time until reaching the event and the at least one vehicle property of the at least one other vehicle, whether or not an overtaking maneuver for overtaking the at least one other vehicle is to be carried out.

The driving assistance method can implement the aspects of the driving assistance system described in this document.

According to a further independent aspect of the present disclosure, a software (SW) program is provided. The SW program can be configured to be executed on one or more processors and to thus carry out the driving assistance method described in this document.

According to a further independent aspect of the present disclosure, a storage medium is provided. The storage medium can comprise an SW program which is configured to be executed on one or more processors and to thus carry out the driving assistance method described in this document.

According to a further independent aspect of the present disclosure, software having program code is provided. The software is configured to carry out the driving assistance method when the software runs on one or more software-controlled apparatuses.

According to a further independent aspect of the present disclosure, a driving assistance system is provided. The driving assistance system comprises one or more processors; and at least one memory which is connected to the one or more processors and contains instructions which can be executed by the one or more processors in order to carry out the driving assistance method described in this document.

A processor or a processor module is a programmable computing mechanism, thus a machine or an electronic circuit which controls other elements according to transferred commands and advances an algorithm (process) in this case.

Exemplary embodiments of the disclosure are shown in the figures and will be described in more detail hereinafter.

### BRIEF DESCRIPTION OF THE DRAWINGS

FIG. 1 schematically shows a driving assistance system for a vehicle according to embodiments of the present disclosure;

FIG. 2 schematically shows a traffic situation in which the ego vehicle decides about an overtaking maneuver according to embodiments of the present disclosure;

FIG. 3 schematically shows a vehicle having a driving assistance system according to embodiments of the present disclosure; and

FIG. 4 is a flow chart of a driving assistance method according to embodiments of the present disclosure.

Identical reference signs are used hereinafter, unless indicated otherwise, for identical and identically acting elements.

### DETAILED DESCRIPTION OF THE DRAWINGS

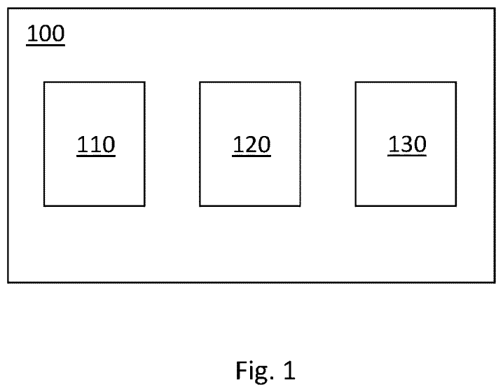

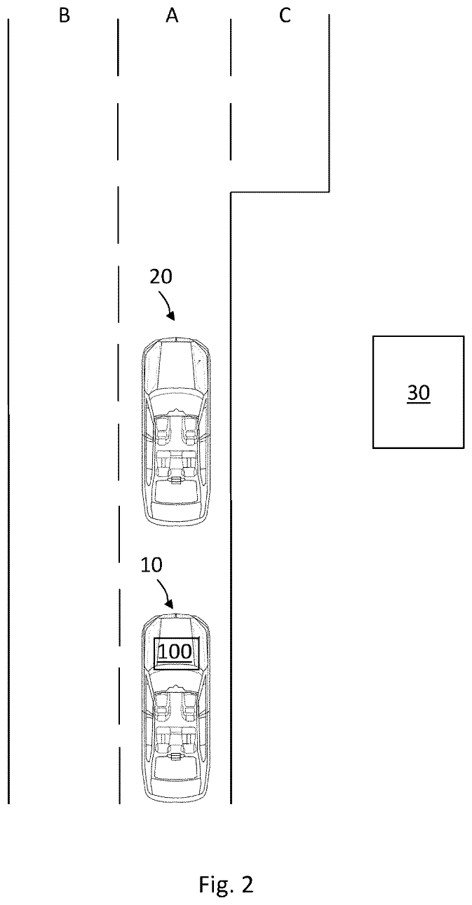

FIG. 1 schematically shows a driving assistance system 100 according to embodiments of the present disclosure. FIG. 2 schematically shows a traffic situation in which the ego vehicle 10, which has the driving assistance system 100, decides about an overtaking maneuver.

An exemplary embodiment of the present disclosure is illustrated hereinafter on the basis of an exit from a multilane road. The present disclosure is not limited thereto, however, and the decision according to the invention about an overtaking maneuver can take place for other events, for example for curves or cornering actions.

A first lane A, a second lane B, adjoining the first lane A, and an exit C are schematically shown. The ego vehicle 10 travels on the first lane A. The other vehicle 20 travels in front of the ego vehicle 10, likewise on the first lane A, at a speed which is less than the speed of the ego vehicle 10.

The ego vehicle 10 comprises the driving assistance system 100 which checks whether an overtaking maneuver having a lane change from the first lane A to the second lane B and back from the second lane B to the first lane A can be carried out safely before reaching the exit C.

The driving assistance system 100 comprises a navigation module 110 configured to provide a travel route for the vehicle 10; an other-vehicle recognition module 120 configured to determine at least one vehicle property of the other vehicle 20 which is located in front of the vehicle 10 on the first lane A; and an assistance module 130 configured to decide, based on a distance and/or time until reaching the event (in this example reaching the exit C) and the at least one vehicle property of the other vehicle 20, whether or not an overtaking maneuver for overtaking the other vehicle 20 should/can be carried out.

The driving assistance system 100 can thus determine whether an overtaking maneuver can still be started or whether the slower other vehicle 20 is followed until the exit C. If sufficient time and route distance is available, the driving assistance system 100 starts the overtaking maneuver or suggests that the overtaking maneuver be carried out to the driver. As a result, the ego vehicle 10, after the lane change back to the first lane A, safely and comfortably reaches the exit C at a matching speed to travel through the exit C.

The decision of whether the overtaking maneuver is to be carried out takes place here based on at least one vehicle property of the other vehicle 20, such as a vehicle speed of the other vehicle 20, an acceleration behavior of the other vehicle 20, a deceleration behavior of the other vehicle 20, lateral guidance of the other vehicle 20 and/or a status of a direction indicator (turn signal on/off) of the other vehicle 20.

The driving assistance system 100 is preferably configured to determine the distance and/or time until reaching the exit C based on surroundings data of a surroundings sensor system of the vehicle 10 and/or digital map data of the navigation module 110 and/or external information which is received from at least one external unit 30, for example, via V2X or a mobile network.

Additionally or alternatively, the driving assistance system 100 can be configured to determine the at least one vehicle property of the other vehicle 20 based on surroundings data of the surroundings sensor system of the vehicle 10 and/or external information which is received from at least one external unit 30.

In some embodiments, the at least one external unit 30 comprises at least one other vehicle and/or a central unit and/or a technical traffic infrastructure.

The assistance module 130 is preferably configured to furthermore decide based on at least one item of vehicle-internal information whether or not the overtaking maneuver for overtaking the other vehicle 20 is to be carried out. The at least one item of vehicle-internal information comprises, for example, an acceleration capacity of the vehicle 10 (for example maximum possible acceleration), a speed limit (for example recognized by traffic sign recognition), an internal speed specification (for example cruise control, maximum comfort speed, etc.), an internal acceleration specification (for example energy efficiency specifications, maximum comfort acceleration, etc.) and/or an internal deceleration specification (for example maximum possible deceleration, maximum comfort deceleration, etc.).

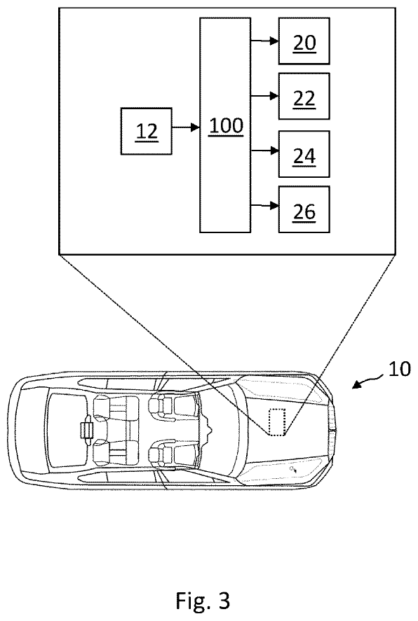

FIG. 3 schematically shows a vehicle 10 having a driving assistance system 100 according to embodiments of the present disclosure.

The driving assistance system 100 can be configured for automated driving and can in particular be an active lane change assistant. In automated driving according to the embodiments of the present disclosure, the lateral guidance (and optionally the longitudinal guidance) of the vehicle 10 takes place automatically. The driving assistance system 100 thus takes over the vehicle guidance. For this purpose, the driving assistance system 100 controls the steering 26 and optionally the drive 20, the transmission 22 and the service brake 24 via intermediate units (not shown).

Surroundings information of a surroundings sensor system which observes the vehicle surroundings is accepted by the driver assistance system 100 for planning and carrying out the automated driving. In particular, the vehicle can comprise at least one surroundings sensor 12 configured to record surroundings data that indicate the vehicle surroundings. The at least one surroundings sensor 12 can comprise, for example, one or more LiDAR systems, one or more radar systems, one or more ultrasonic sensors and/or one or more cameras.

The driving assistance system 100 of the present disclosure comprises a lane change assistant or is a lane change assistant or can implement the functionalities of the lane change assistant to overtake the slower other vehicle.

The driving assistance system 100 comprises in some embodiments an actuating element for a directional indicator, wherein the actuating element can be configured to carry out, upon actuation or triggering by a driver, in an automated manner the overtaking maneuver of the slower other vehicle having the associated lane changes. The actuating element can be a turn signal lever here and can have a multiple function, namely activating the directional indicator and triggering the automatic overtaking maneuver.

However, the embodiments of the present disclosure are not restricted to automated driving. In alternative embodiments, the driving assistance system 100, using at least one output device, can output driver notifications with respect to the overtaking maneuver when the vehicle is being manually driven. The driver notifications can give the driver notifications on the overtaking maneuver, in particular on the lane changes, for example whether these are possible, impossible, nonhazardous, hazardous, advantageous, etc. For example, the driving assistance system 100 can suggest the overtaking maneuver or the associated lane changes if they are possible and/or advantageous and/or nonhazardous.

The at least one output device can comprise at least one display device and/or at least one loudspeaker. The at least one display device can comprise a display, in particular an LCD display, a plasma display or an OLED display. Additionally or alternatively, the at least one display device can comprise a projection device configured to show information directly in the field of view of the driver, in particular to project it on a windshield. In some embodiments, the at least one display device can be a central information output device of an infotainment system, such as a head unit or a pillar-to-pillar display. The at least one output device is preferably permanently installed in the vehicle.

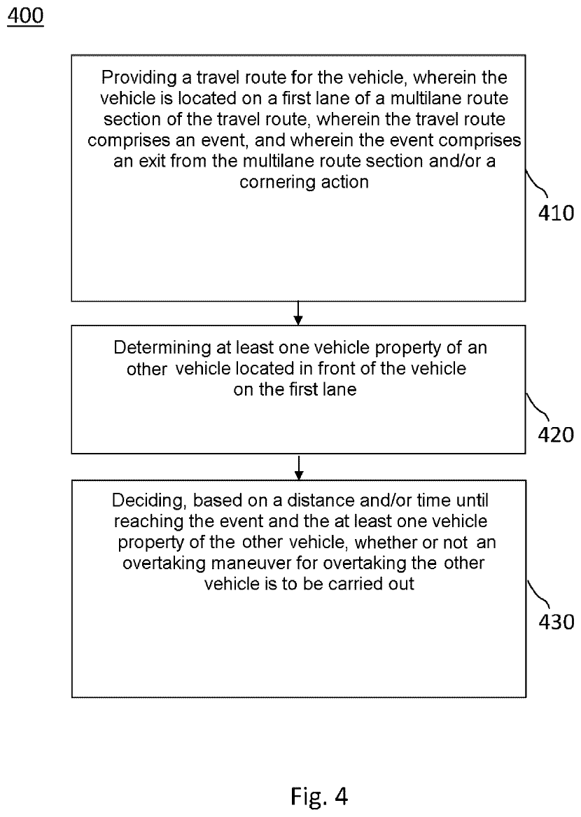

FIG. 4 shows a flow chart of a driving assistance method 400 according to embodiments of the present disclosure. The driving assistance method 400 can be implemented by corresponding software which is executable by one or more processors (for example a CPU).

The driving assistance method 400 comprises, in block 410, providing a travel route for the vehicle, wherein the vehicle is located on a first lane of a multilane route section of the travel route, wherein the travel route comprises an event, and wherein the event comprises an exit from the multilane route section and/or a cornering action; in block 420, determining at least one vehicle property of an other vehicle located in front of the vehicle on the first lane; and, in block 430, deciding, based on a distance and/or time until reaching the event and the at least one vehicle property of the other vehicle, whether or not an overtaking maneuver for overtaking the other vehicle is to be carried out.

According to the invention, the driving assistance system observes an other vehicle traveling in front of the vehicle and potentially to be overtaken. In particular, the driving assistance system can observe a movement status of the other vehicle, such as a longitudinal speed, a longitudinal and/or lateral acceleration, a turn signal status, etc. Moreover, the driving assistance system determines a distance and/or time until reaching the event, thus the exit or curve. Based on this information and optionally in consideration of further factors (for example an acceleration potential of the vehicle), the driving assistance system calculates whether it is possible to overtake the other vehicle by the time until reaching the event, so that a subsequent maneuver for safely passing the event is possible. If a calculated quality measure is not sufficient or is not calculable, lane changes for overtaking can be suppressed. As a result, an improved driving strategy with respect to lane changes for a specified travel route can be provided, so that reliable operation of the lane change assistant can be enabled and safety in road traffic can be improved.

Although the invention was illustrated and explained further in detail by preferred exemplary embodiments, the invention is not thus restricted by the disclosed examples and other variations can be derived therefrom by a person skilled in the art without departing from the scope of protection of the invention. It is therefore clear that a variety of possible variations exist. It is likewise clear that embodiments mentioned as examples actually only represent examples which are not to be interpreted in any way as a limitation, for example, of the scope of protection, the possible applications or the configuration of the invention. Rather, the preceding description and the description of the figures make a person skilled in the art capable of specifically implementing the exemplary embodiments, wherein a person skilled in the art with knowledge of the disclosed concept of the invention can perform manifold modifications for example with respect to the function or the arrangement of individual elements mentioned in an exemplary embodiment without departing from the scope of protection defined by the claims and their legal equivalents, such as more extensive explanations in the description.

1.-10. (canceled)

11. A driving assistance system for a vehicle, comprising:
a navigation module configured to provide a travel route for the vehicle, wherein the vehicle is located on a first lane of a multilane route section of the travel route, wherein the travel route comprises an event,
an other-vehicle recognition module configured to determine at least one vehicle property of at least one other vehicle located in front of the vehicle on the first lane; and
an assistance module configured to decide, based on a distance and/or time until reaching the event and the at least one vehicle property of the at least one other vehicle, whether or not an overtaking maneuver for overtaking the at least one other vehicle is to be carried out.

12. The driving assistance system according to claim 11, wherein
the event comprises an exit from the multilane route section and/or a cornering action and/or a reduction of a number of lanes.

13. The driving assistance system according to claim 11, wherein the at least one vehicle property of the at least one other vehicle comprises one or more of:
a vehicle speed of the other vehicle;
an acceleration behavior of the other vehicle;
a deceleration behavior of the other vehicle;
lateral guidance of the other vehicle; or
a status of a direction indicator of the other vehicle.

14. The driving assistance system according to claim 13, wherein
the at least one vehicle property of the at least one other vehicle comprises the vehicle speed of the other vehicle, and
the assistance module is configured to decide, in consideration of the distance and/or the time until reaching the event, that the overtaking maneuver for overtaking the at least one other vehicle is to be carried out when the vehicle speed of the at least one other vehicle is less than a vehicle speed of the vehicle and to decide that the overtaking maneuver for overtaking the at least one other vehicle is not to be carried out when the vehicle speed of the at least one other vehicle is equal to or greater than the vehicle speed of the vehicle.

15. The driving assistance system according to claim 11, wherein the driving assistance system is configured to:
determine the distance and/or time until reaching the event based on surroundings data of a surroundings sensor system of the vehicle and/or digital map data of the navigation module and/or external information which is received from at least one external unit; and/or
determine the at least one vehicle property of the at least one other vehicle based on surroundings data of a surroundings sensor system of the vehicle and/or external information which is received from at least one external unit.

16. The driving assistance system according to claim 11, wherein
the assistance module is configured to further decide based on at least one item of vehicle-internal information whether or not the overtaking maneuver for overtaking the at least one other vehicle is to be carried out, and
the at least one item of vehicle-internal information comprises one or more of:
an acceleration capacity of the vehicle;
a speed limit;
an internal speed specification,
an internal acceleration specification, or
an internal deceleration specification.

17. The driving assistance system according to claim 16, wherein
the internal speed specification is a driver speed specification; and/or
the internal acceleration specification is a driver acceleration specification; and/or
the internal deceleration specification is a driver deceleration specification.

18. The driving assistance system according to claim 11, wherein
the assistance module is configured to further decide based on a speed specification for the event whether or not the overtaking maneuver for overtaking the at least one other vehicle is to be carried out.

19. The driving assistance system according to claim 18, wherein
the assistance module is configured to decide, in consideration of the at least one vehicle property of the at least one other vehicle and the distance and/or the time until reaching the event, that the overtaking maneuver for overtaking the at least one other vehicle is to be carried out when the speed specification for the event is achievable by the time until reaching the event and to decide that the overtaking maneuver for overtaking the at least one other vehicle is not to be carried out when the speed specification for the event is not achievable by the time until reaching the event.

20. The driving assistance system according to claim 11, wherein the assistance module is configured to:
carry out the overtaking maneuver for overtaking the at least one other vehicle in an automated manner when it is decided that the overtaking maneuver is to be carried out, wherein the overtaking maneuver comprises a first lane change from the first lane to a second lane of the multilane route section of the travel route and a second lane change back from the second lane to the first lane; and/or
actuate at least one output device to output at least one driver notification with respect to the decision on the overtaking maneuver.

21. A vehicle comprising the driving assistance system according to claim 11.

22. A driving assistance method for a vehicle, comprising:
providing a travel route for the vehicle, wherein the vehicle is located on a first lane of a multilane route section of the travel route, wherein the travel route comprises an event;
determining at least one vehicle property of at least one other vehicle which is located in front of the vehicle on the first lane; and
deciding, based on a distance and/or time until reaching the event and the at least one vehicle property of the at least one other vehicle, whether or not an overtaking maneuver for overtaking the at least one other vehicle is to be carried out.

24. A computer product comprising a non-transitory computer readable medium having stored thereon program code which, when executed on one or more processors, carries out the acts of:
providing a travel route for the vehicle, wherein the vehicle is located on a first lane of a multilane route section of the travel route, wherein the travel route comprises an event,
determining at least one vehicle property of at least one other vehicle which is located in front of the vehicle on the first lane; and
deciding, based on a distance and/or time until reaching the event and the at least one vehicle property of the at least one other vehicle, whether or not an overtaking maneuver for overtaking the at least one other vehicle is to be carried out.

23. The method according to claim 22, wherein the event comprises an exit from the multilane route section and/or a cornering action and/or a reduction of a number of lane.
